(19) United States
(12) Patent Application Publication
(10) Pub. No.: US 2025/0138834 A1
(43) Pub. Date: May 1, 2025

(54) SYSTEMS AND METHODS FOR MANAGING SERVICES FOR DEVICES

(71) Applicant: Samsung Electronics Co., Ltd., Suwon-si (KR)

(72) Inventors: Somnath ROY, San Ramon, CA (US); Mayank SAXENA, Livermore, CA (US); Ronald LEE, Pleasanton, CA (US)

(21) Appl. No.: 18/934,161

(22) Filed: Oct. 31, 2024

Related U.S. Application Data
(60) Provisional application No. 63/546,738, filed on Oct. 31, 2023.
(60) Provisional application No. 63/699,792, filed on Sep. 26, 2024.

(51) Int. Cl. G06F 9/4401

(52) U.S. Cl. CPC G06F 9/4411

(57) ABSTRACT

A system and a method for managing services for devices are disclosed. An upstream interface set is configured to communicate with an application that requests a device service using a device. A downstream interface set is configured to include a device service functionality that provides the device service customized to the device. The device is integrated with the application. A processing element is configured to process communication requests between the upstream interface set and the downstream interface set.

### CROSS-REFERENCE TO RELATED APPLICATION

This application claims the priority benefit under 35 U.S.C. § 119 (e) of U.S. Provisional Application No. 63/546,738 filed on Oct. 31, 2023, and U.S. Provisional Application No. 63/699,792 filed on Sep. 26, 2024, the disclosures of which are incorporated by reference in its entirety as if fully set forth herein.

### TECHNICAL FIELD

The disclosure generally relates to software framework. More particularly, the subject matter disclosed herein relates to software framework for device services.

### BACKGROUND

Advances in high computing, servers, and storage technologies have opened many opportunities for enhancing performance and throughput of computing systems. These opportunities include solutions using hardware, software, and combination of hardware and software. Design solutions for data and services for these systems often encounter many challenges. Managing multiple layers of devices in a heterogeneous environment presents difficulties in integration, interoperability, scalability, and long-term maintenance and support. In addition, different levels in user preferences and applications complexity may lead to issues in security, access control, device monitoring, and consistency of device services.

### SUMMARY

To overcome these issues, systems and methods are described herein for a technique of managing services for devices. The technique aims at providing an extensible management and IO framework that can add support to present and future device technologies without any change within the core framework code or its application programming interface (API) set. The framework is implemented using modularized plug-and-play components where new feature service modules for the new technologies can be added by well-defined feature interface set.

In an embodiment, a system and a method for managing device services are disclosed. An upstream interface set is configured to communicate with an application that requests a device service using a device. A downstream interface set is configured to include a device service module that provides the device service customized to the device. The device is integrated with the application. A processing element is configured to process communication requests between the upstream interface set and the downstream interface set.

### BRIEF DESCRIPTION OF THE DRAWINGS

In the following section, the aspects of the subject matter disclosed herein will be described with reference to exemplary embodiments illustrated in the figures, in which:

FIG. 1 is a block diagram illustrating a system according to an embodiment.

FIG. 2 is a diagram illustrating a processing element according to an embodiment.

FIG. 3 is a diagram illustrating a downstream interface set according to an embodiment.

FIG. 4 is a diagram illustrating a service-to-device path according to an embodiment.

FIG. 5 is a diagram illustrating a set of functions in the upstream interface set according to an embodiment.

FIG. 6 is a diagram illustrating a set of functions in the downstream interface set according to an embodiment.

FIG. 7 is a flowchart illustrating an framework process according to an embodiment.

FIG. 8 is a diagram illustrating a computing system according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

The term “abstract” as used herein as a verb refers to an act of considering apart from application to or association with a particular instance. The term “abstraction” as used herein as a now refers to a process or a state where general concepts are derived from specific examples or instances. The term “upstream” or “north” as used herein refers to the logical location in vicinity of the user or the user application. It is closest to the application. The term “downstream” or “south” as used herein refers to the logical location in vicinity of the device or devices being utilized by the application. The term “circuit” as used herein may refer to a hardware component or a functionality embodied in a hardware component which may be formed by instructions in a memory and executed by a programmable processor.

There is an open standard cache-coherent interconnect between processors and accelerators, and memory devices. Quad-level cell (QLC) for solid-state drives (SSDs) uses four-bit layers per cell to provide high storage density and low read latency. Together with storage technologies, data integration allows integrating data using extract, transform, and load (ETL) operations. Zero-ETL provides fast data transfers without the need for any intermediary steps to transform the data or creating the ETL pipeline. To utilize these solutions, developers implement specific services to provide accesses to applications. These services have their own Application Programming Interface (API) set. There are several problems of the existing techniques in using these services. Back-end applications need to be changed to be integrated with different service offerings such as cache coherent protocol services, QLC services, zero ETL services, and different statistical or event monitoring services. In addition, if any of these services requires storage input/output (IO) accesses, e.g., device read/write, these services' codes need to be changed to accommodate different storage frameworks such as file system, asynchronous IO (AIO), and storage performance development kit (SPDK).

To address the above issues, a system and a method for managing device services are disclosed. An upstream interface set is configured to communicate with an application that requests a device service using a device. A downstream interface set is configured to include a device service module that provides the device service customized to the device. The device is integrated with the application. A processing element is configured to process communication requests between the upstream interface set and the downstream interface set.

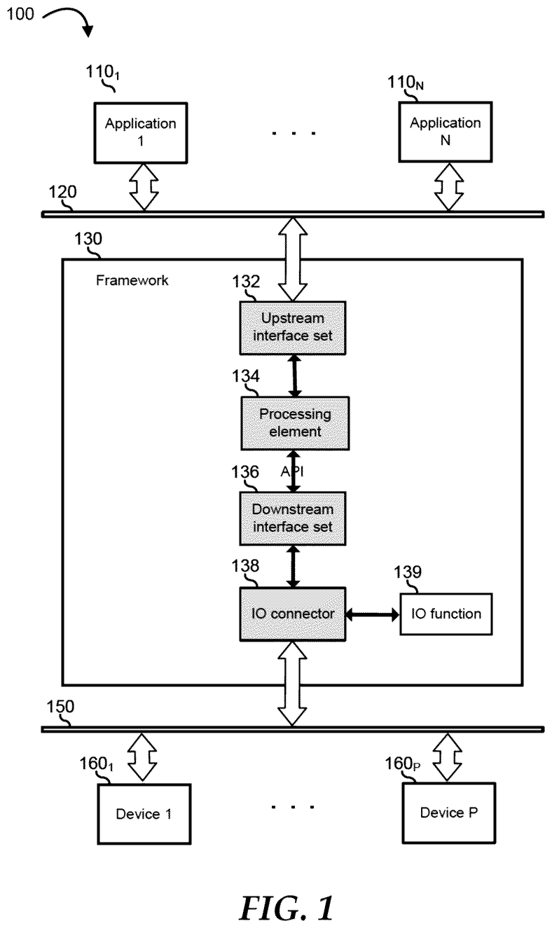

FIG. 1 is a block diagram illustrating a system 100 according to an embodiment. The system 100 includes N applications 110ₖ's (k=1, . . . , N), a framework 130, and P devices 160ₖ's (k=1, . . . , P). The system 100 may include more or less than the above elements. For clarity, the subscript may be dropped and the numeral reference 160 may refer to a single device or multiple devices.

The application 110 may represent any application that employs a service using the device 160. The service may be a tool or a support package that is designed to facilitate the use of the device 160. This tool may be a software platform, a module, or a functionality that is geared specifically toward a specific device that the application 110 wants to utilize. The application 110 may be developed by a user or a company who wants to exploit the features of the device 160 in the application. The service may be offered by the manufacturer of the device 160 or a third-party vendor. The device 160 may be any device that is used by the application 110. It may be a semiconductor device, a mechanical apparatus, or an optical element. In one embodiment, the device 160 is a solid-state drive (SSD).

The framework 130 is a software platform that provides a development and run-time environment for the application 110 to use the device 160. It provides device services to the application 110 to use the device 160 efficiently because the framework 130 is developed specifically for the device 160 and its variations. The framework 130 reduces the development efforts of users or customers in incorporating the device 160 in their applications. It is designed to be easily integrated into the users or customers' infrastructure and associated applications. It achieves this by offering an extensible service, or device processing, set that can be extended to include service modules for new devices. The framework 130 also includes modularized modules for services and other administrative functions. It can be used in a plug-and-play environment. In one embodiment, the framework 130 includes an upstream or north application programming interface (API), or interface set 132, a processing element or internal core 134, a downstream or south API, or interface, set 136, and an input/output (IO) connector 138. The framework 130 may include more or less than the above components. The terms “north” and “south” refer to the relative logical locations of the interface sets with respect to the processing element 134.

The upstream interface set 132 is configured to communicate with the application 110 that requests a device service using the device 160. It may be integrated with the application 110 or any back-end software defined storage (SDS). It may communicate with the application 110 through a link or connection 120. The link or connection 120 may be physical (e.g., wires, electromagnetic waves) or logical (e.g., virtual).

The processing element 134 is configured to process communication requests between the upstream interface set and the downstream interface set. It is hidden from the users or applications and include functionalities that are used internally within the framework 130. Examples of the communication requests may include issuance of commands from the application 110 to the device 160, transmission of credentials or authentication details to use the device service, and reporting the status of execution from the device 160 to the application 110

The downstream interface set 136 is configured to include a device service functionality or circuit that provides the device service customized to the device so that the device is integrated with the application. The device service circuit becomes part of a service, or device processing, set that provides several services to deploy one or more devices 160. The downstream interface set 136 receives information including commands from the application in the form of command identifiers via the processing element 134 and directs the command or commands to the appropriate device service module for execution.

The IO connector 138 is configured to be integrated with an IO function 139 that accesses the device 160. The IO connector 138 is a software construct that performs operations involving IO accesses to the device 160. It may assist in IO tasks such as data transfers, read and write operations, and data collection. The IO connector interface with the device 160 via a link or connection 150 which may be physical or logical.

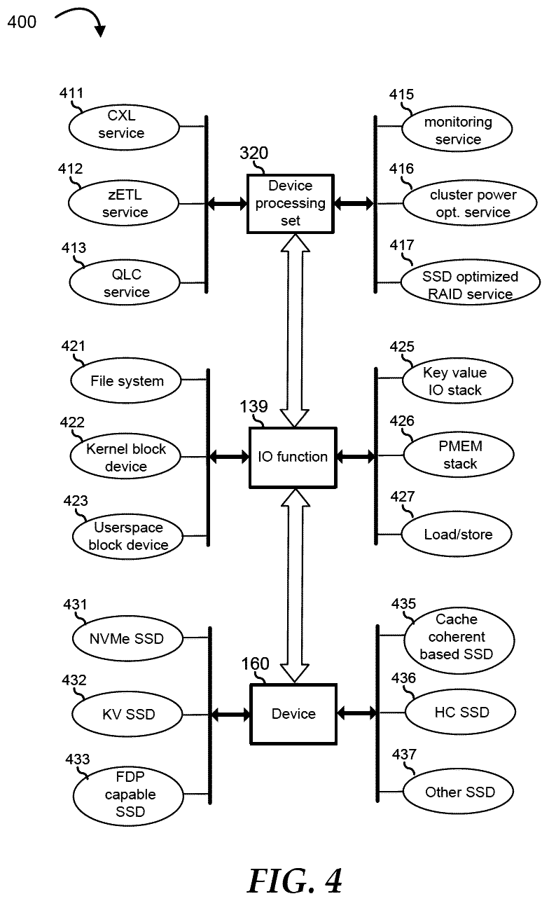

The device 160 may be any device that is used by the application 110. It may be accessible via the link or connection 150. It may be a semiconductor device, a mechanical apparatus, or an optical element. In one embodiment, the device 160 is a solid-state drive (SSD). FIG. 4 describes further about different types of services and various types of SSD that the framework 130 may support.

The framework or system 130 creates an abstraction of the specific details of the service modules and device 160 to help the application 110 to deploy the device 160 through the corresponding device service with ease. The framework 130 may decouple the application 110 from the interaction semantics of the device 160. The users or customers are free from the particular requirements and low-levels details of the device 160 and need only to be concerned with the high-level abstract description. In one embodiment, through the upstream interface set 132, the application 110 may access or deploy the device 160 with or without through the device service. The abstraction created by the framework 130 may include a pass-through feature that allows the application to access the device 160 through the upstream interface set 132 without going through the device service.

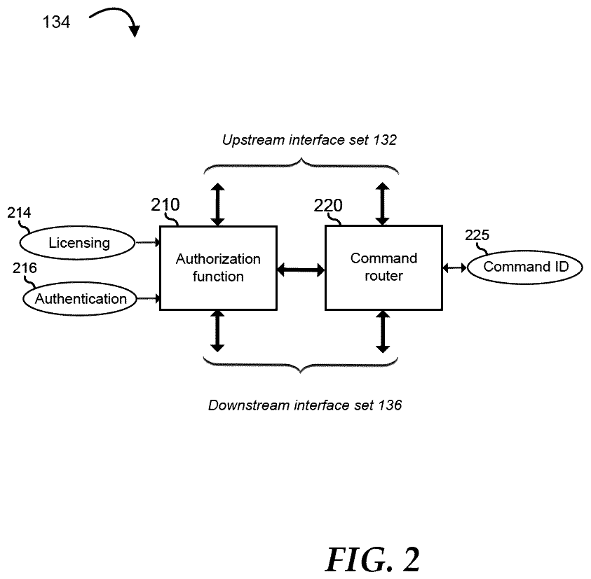

FIG. 2 is a diagram illustrating the processing element 134 according to an embodiment. The processing element 134 includes an authorization function 210 and a command router 220. The processing element 134 may include more or less than the above elements. For example, the processing element 134 may include an administration module (not shown) that performs administrative tasks such as registration of command identifiers, feature or service description. The authorization function 210 and the command router 220 interact with the upstream interface set 132 and the downstream interface set 136.

In one embodiment, the authorization function 210 receives licensing information 214 and authentication data 216 and determines whether the application 110 is permitted to use the device service in deploying the device 160. The licensing information 214 provides information regarding the licensing of the device service and the identity of the licensee. If the licensing expires, the authorization function 210 will not permit the application 110 to use the device service and may return an error message to the application 110. The authentication data 216 includes information or data regarding the credentials or identity of the user or the customer if such security measure is being enforced. If the credentials or identity data do not match those on file, the authorization function 210 will not permit the application 110 to use the device service and may return an error message to the application 110.

The command router 220 is configured to route a command identifier (ID) 225 of the command as part of the communication requests or function calls by the application to the corresponding device service circuit. The application 110 does not need to describe the command in great details and needs only to use the command ID to pass of command requests. In one embodiment, the command router 220 examines the command ID or feature ID and routes the request to the corresponding device service/feature or the device 160. In one embodiment, the downstream application interfaces are the same for all the devices 160's. All features or devices may implement the same downstream application interfaces but each registers with the processing element 134 by giving its command or feature ID and the description details of the feature or service. When the application 110 wants to consume or invoke a feature or device service, it will invoke the upstream application interfaces with interested feature or command ID. The command router 220 will route the request to the corresponding feature or device service. The downstream interface set 136 will look up the command ID 225 and pass the call to the appropriate function to execute the command. After a device service or device 160 receive a request, it will check if there is/are any user-supplied function/functions it needs to execute for this command. If so, it will execute the user-supplied function/functions in order to create a command execution pipeline. Otherwise, it will execute its default function.

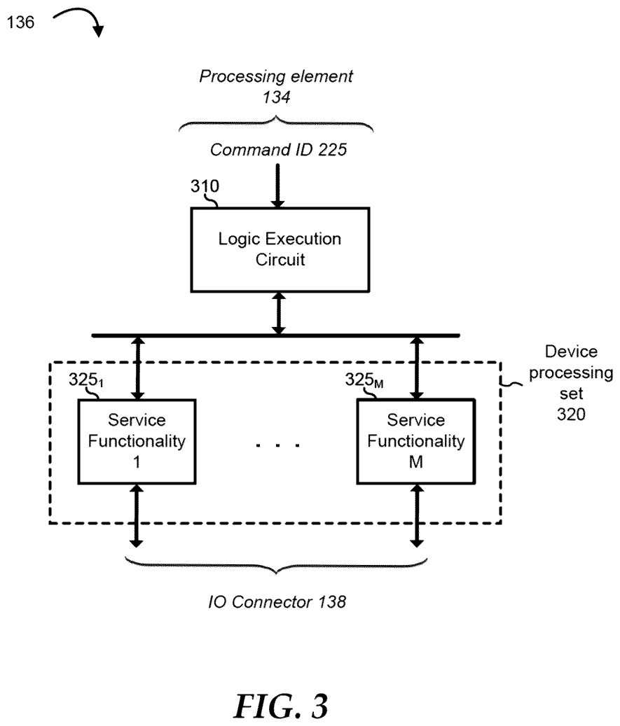

FIG. 3 is a diagram illustrating the downstream interface set 136 according to an embodiment. The downstream interface set 136 includes a logic execution module or functionality or circuit 310 and a service, or device processing, set 320. The downstream interface set 136 may include more or less than the above elements.

The logic execution circuit 310 provides specific functions to perform requested operations. These functions may include operations involving logic manipulations of data, decision branches, execution of specific commands, or any operations that are part of a device service. Among other information or data, the logic execution circuit 310 receives a command ID 225 from the command router 220 in the processing element 134. As mentioned above, the logic execution circuit 310 looks up the command ID 225 to obtain the corresponding function that performs the command specified by the command ID 225. The logic execution circuit 310 interacts with the service, or device processing, set 320. In one embodiment, application-specific logic execution function for a particular feature/service module may be added dynamically. A user or application may have a single or multiple execution functions as part of the command/service they want to execute. In essence, this provision enables a user or an application to create a custom execution pipeline.

The service, or device processing, set 320 is a set of service modules that are available for use with the device 160. It includes M service modules 325ⱼ's where j=1, . . . , M. For brevity and ease of references, the subscript may be dropped. Each of these service modules performs a service with the device 160. FIG. 4 describes further these services. The service, or device processing, set 320 is extensible by including new service module or functionality. To further enhance the performance, the service modules or functionalities 325ⱼ's may be modularized such that adding a new service module does not require changing any existing modules in the service set 320. The service modules or functionalities 325ⱼ's interact with the IO connector 138 to access the device 160. The IO connector 138 may be used to interact with the device 160 or any other third-party devices to read/write information.

FIG. 4 is a diagram illustrating a service-to-device path 400 according to an embodiment. The service-to-device path 400 shows the path that a service requested by the application 110 goes through in accessing the device 160. The service-to-device path 400 involves the device processing set 320, the IO function 139, and the device 160. The service-to-device path 400 may involve more or less than the above elements.

The device processing set 320 includes a cache coherent protocol service 411, a zETL service 412, a QLC service 413, a monitoring service 415, a cluster power optimization service 416, and an SSD optimized redundant array of inexpensive disks (RAID) service 427. The device processing set 320 may include more or less than the above services. These services correspond to the service modules 325₁ to 325_{M} shown in FIG. 3. These services are known to one skilled in the art and are not further discussed in detail. For example, the cache coherent protocol service 411 supports operations involving the open standard interconnect. It may provide operations involving an SSD that maintains coherency between a processor's memory and the device 160, expand capacity, compose performance, availability, security, and mobility. As another example, software (SW) RAID is a method of implementing RAID entirely through software without the need for dedicated hardware components. The SSD optimized RAID service 427 may provide service to use the SSDs as RAID. The device processing set 320 may also include a device service suitable for the device 160. For example, for an image sensor, a device service may be image sensor service which may include calibration function, read function, and reset function.

The IO function 139 includes IO operations that involve the device 160. The IO operations include a file system operation 421, a kernel block device operation 422, a userspace block device operation 423, a key value IO stack operation 425, and a PMEM stack operation 426, and any other function 427 related to the device 160. Some of these functions are known to one skilled in the art and may not need further description. For example, a kernel block device for an SSD is a hardware component that stores data in fixed-size blocks, or chunks of space.

The device 160 includes a non-volatile memory express (NVMe) solid-state drive (SSD) 431, a key value (KV) SSD 432, a flexible data placement (FDP) capable SSD 433, a cache coherent protocol based SSD 435, a high-capacity (HC) SSD 436, and other device 437. The device 437 may be another type of SSD or any other type. Examples of other non-SSD devices may include any semiconductor devices (e.g., memories, peripheral devices, network devices, programmable processors, graphics processors, signal processing devices, sensors), optical (e.g., lenses, light sources, optical assemblies), mechanical, electromechanical, biomedical instruments, etc.

While the services, IO functions, and devices may be known to one skilled in the art, existing techniques to use these elements suffer several disadvantages as mentioned in the background section. The framework or system 130 provide an efficient and cost-effective solution that avoids these disadvantages and problems. The upstream and downstream interface sets 132 and 136 and the processing element 134 hide the specific details of implementation from the application 110. The application 110 does not need to know these specific details. In addition, the modules and functions are developed in a modularized form to provide a plug-and-play environment. These modularized modules or functions do not overlap each other and typically are independent except when passing parameters to one another for execution. The architecture is also extensible in that new service modules can be added to a service set without the need to revise or modify existing service modules.

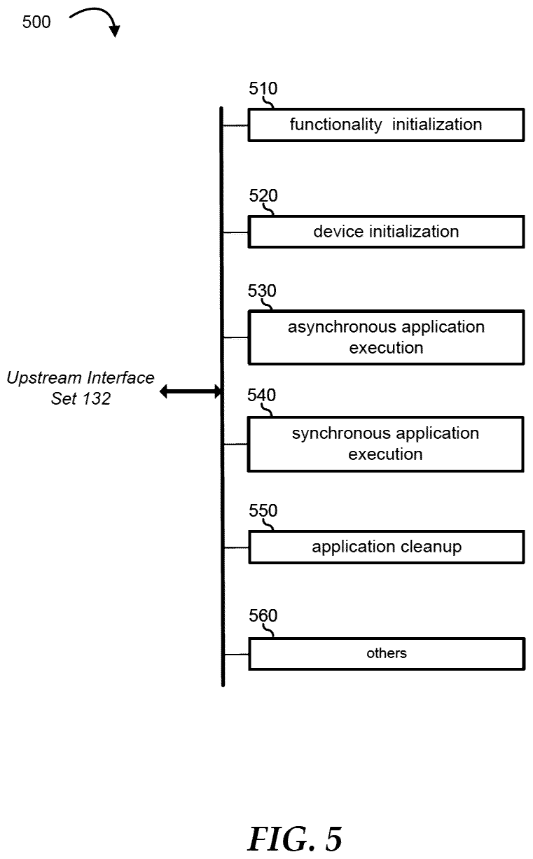

FIG. 5 is a diagram illustrating a set 500 of functions in the upstream interface set 132 according to an embodiment. The set 500 includes at least a functionality initialization function 510, a device initialization function 520, an asynchronous application execution function 530, a synchronous application execution function 540, an application cleanup function 550, and other functions 560. The set 500 may include more or less than the above functions. The implementation of these functions is platform and language specific. Therefore, only functional description is provided to illustrate the extensible and modularized aspects of the framework 130. In addition, not all functions are required. Some are optional.

The functionality initialization function 510 configures the device services in the framework 130 and initializes all the service modules in the framework 130. Since each of these service modules has its own initialization function, the module initialization function 510 needs only invoking these initialization functions. Thereafter, the functionality initialization function 510 loads the execute functions to be called later.

The device initialization function 520 configures and initializes the device 160 that is called by the application 110. This may include accessing the device contexts and other device-related data. The asynchronous application execution function 530 does not block the calling application and notifies the calling function later when the execution is finished. The synchronous application execution function 540 blocks the calling application until the execution is finished. The application cleanup function 550 clears, releases, or cleans up allocated data structures, file handles, and other elements that may have been created during initialization and configuration. The other functions 560 may be any other functions as appropriate.

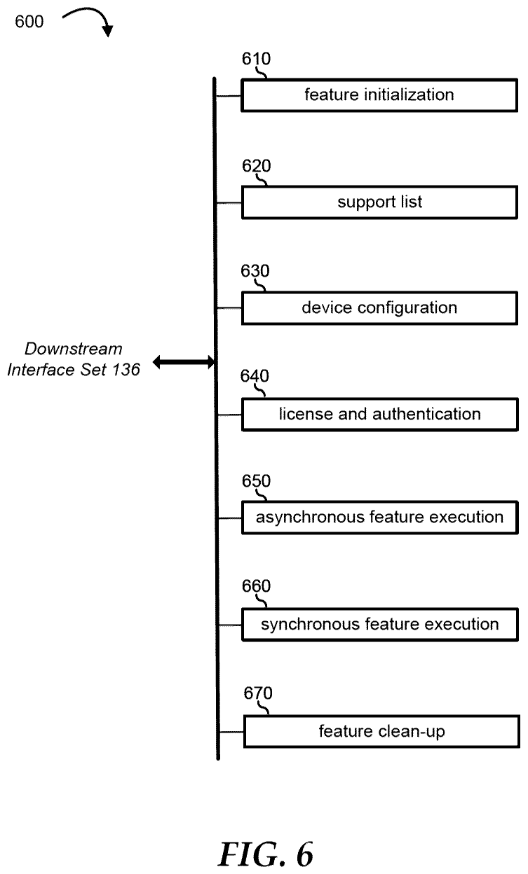

FIG. 6 is a diagram illustrating a set 600 of functions in the downstream interface set according to an embodiment. The set 600 includes at least a feature initialization function 610, a support list function 620, a device configuration function 630, a license and authentication function 640, an asynchronous feature execution function 650, a synchronous feature execution function 660, and a feature clean-up function 670. The set 600 may include more or less than the above functions. The implementation of these functions is platform and language specific. Therefore, only functional description is provided to illustrate the extensible and modularized aspects of the framework 130. In addition, not all functions are required. Some are optional.

Some of the functions in the set 600 are similar to their counterparts in the set 500 and the description may be omitted. The main difference between the set 600 and the set 500 is that the set 600 is designed for the service and the device side while the set 500 is designed for the application side. As an example, the asynchronous feature execution function 650 and the synchronous feature execution function 660 are similar to the asynchronous application execution function 530 and the synchronous application execution function 540, respectively, when the same command is routed through the application to the service module. Similarly, the feature initialization function 610, the device configuration function 630, and the feature clean-up function 670 are similar to the functionality initialization 510, the device initialization function 520, and the application cleanup function 550, respectively.

The support list function 620 provides a list of the service functionalities that the framework 130 supports. The service functionalities may be listed by their respective identifiers. Since the framework 130 is extensible, this function is updated each time a new service functionalities is added to the service, or device processing, set. The license and authentication function 640 validates the license based on the authorization function 210.

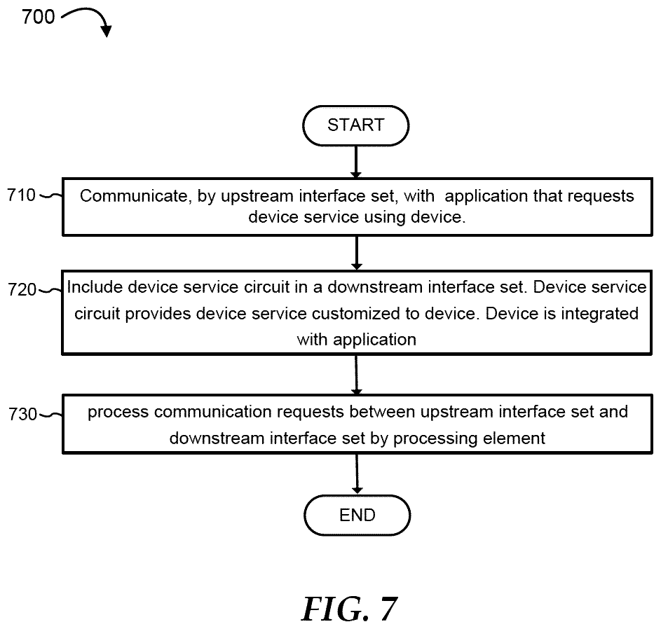

FIG. 7 is a flowchart illustrating a framework process 700 according to an embodiment. Upon START, the process 700 communicates, by an upstream interface set, with an application that requests a device service using a device (Block 710). Next, the process 700 includes a device service circuit in a downstream interface set (Block 720). The device service circuit provides the device service customized to the device. The device is integrated with the application. Then, the process 700 processes communication requests between the upstream interface set and the downstream interface set by a processing element (Block 730). Examples of the communication requests include issuance of commands and report status. The process 700 is then terminated.

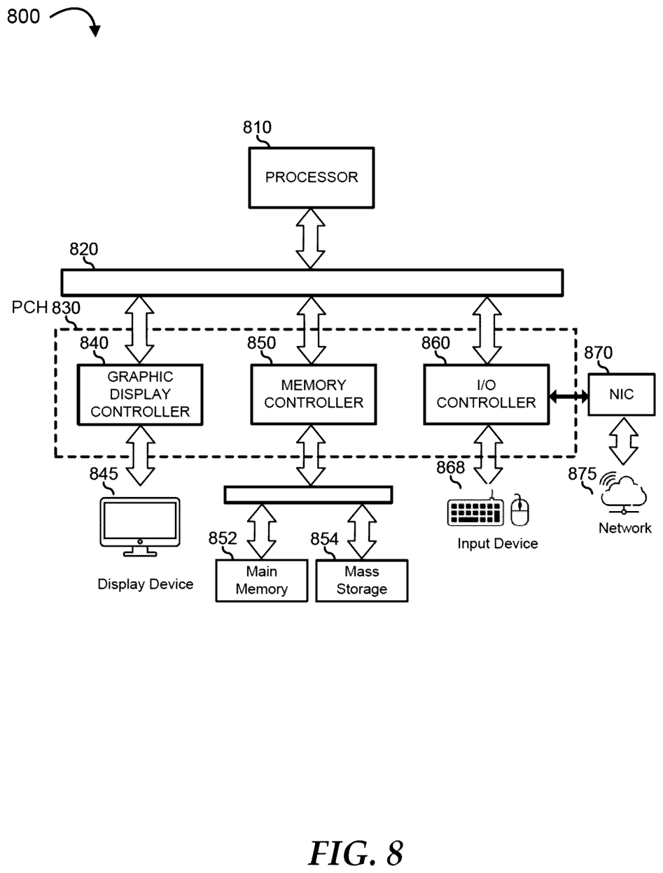

FIG. 8 is a diagram illustrating a computing or processing system 800 according to an embodiment. The computing system 800 may be a system on which the framework 130 operates. It includes a central processing unit (CPU) or a processor 810, a platform controller hub (PCH) 830, and a bus 820. The PCH 830 may include a graphic display controller (GDC) 840, a memory controller 850, and an input/output (I/O) controller 860. The processing system 800 may include more or less than the above components. In addition, a component may be integrated into another component. As shown in FIG. 8, all the controllers 840, 850, and 860 are integrated in the PCH 830. The integration may be partial and/or overlapped. For example, the GDC 840 may be integrated into the processor 810, the I/O controller 860 and the memory controller 850 may be integrated into one single controller, etc.

The processor 810 is a programmable device that may execute a program or a collection of instructions to carry out a task. It may be a general-purpose processor, a digital signal processor, a microcontroller, or a specially designed processor such as one design from Applications Specific Integrated Circuit (ASIC). It may include a single core or multiple cores. Each core may have multi-way multi-threading. The processor 810 may have simultaneous multithreading feature to further exploit the parallelism due to multiple threads across the multiple cores. In addition, the processor 810 may have internal caches at multiple levels.

The bus 820 may be any suitable bus connecting the processor 810 to other devices, including the PCH 830. For example, the bus 820 may be a Direct Media Interface (DMI).

The PCH 830 in a highly integrated chipset that includes many functionalities to provide interface to several devices such as memory devices, input/output devices, storage devices, network devices, etc.

The I/O controller 860 controls input devices 868 (e.g., stylus, keyboard, and mouse, microphone, image sensor) and output devices (e.g., audio devices, speaker, scanner, printer). It also has a network interface card (NIC) 870 which provides interface to a network and wireless medium 875.

The memory controller 850 controls memory devices such as a main memory 852 and a mass storage 854. The main memory 852 includes random access memory (RAM) and/or the read-only memory (ROM) and other types of memory such as the cache memory or an SSD. The mass storage 854 may also include CD-ROM, hard disk, and SSDs. The SSDs may be used with the framework 130 as described above. The main memory 852 may store instructions or programs, loaded from a mass storage device, that, when executed by the processor 810, cause the processor 810 to perform operations as described above. It may also store data used in the operations. The ROM may include instructions, programs, constants, or data that are maintained whether it is powered or not. The instructions or programs may correspond to the functionalities described above, such as the framework 130.

The GDC 840 controls a display device 845 and provides graphical operations. It may be integrated inside the processor 810. It typically has a graphical user interface (GUI) to allow interactions with a user who may send a command or activate a function.

Additional devices or bus interfaces may be available for interconnections and/or expansion. Some examples may include the Peripheral Component Interconnect Express (PCIe) bus, the Universal Serial Bus (USB), etc.

All or part of an embodiment may be implemented by various means depending on applications according to particular features, functions. These means may include hardware, software, or firmware, or any combination thereof. A hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A system comprising:
an upstream interface set configured to communicate with an application that requests a device service using a device;
a downstream interface set configured to include a device service module that provides the device service customized to the device, the device being integrated with the application; and
a processing element configured to process communication requests between the upstream interface set and the downstream interface set.

2. The system of claim 1, wherein the downstream interface set comprises:
a logic execution circuit configured to execute a command in the device service; and
a device processing set configured to be extended to include the device service module.

3. The system of claim 2, wherein the processing element comprises:
a command router configured to route a command identifier of the command as part of the communication requests by the application to the device service module; and
an authorization function configured to authorize the application to use the device service based on at least one of a licensing requirement and an authentication operation.

4. The system of claim 1 further comprising:
an input/output (IO) connector configured to be integrated with an IO function that accesses the device.

5. The system of claim 4, wherein the device is one of a non-volatile memory express (NVMe) solid-state drive (SSD), a key value (KV) SSD, a flexible data placement (FDP) capable SSD, a cache coherent protocol based SSD, and a high-capacity (HC) SSD.

6. The system of claim 1, wherein the device service is one of cache coherent protocol service, zero-Extract Transform and Load (ETL) service, Quad-level cell (QLC) service, monitoring service, cluster power optimization service, and SSD optimized redundant array of inexpensive disks (RAID) service.

7. The system of claim 4, wherein the device service uses the input/output (IO) function to access the device.

8. The system of claim 7, wherein the IO function performs one of a file system operation, a kernel block device operation, a userspace block device operation, a key value IO stack operation, a persistent memory (PMEM) stack operation, and a load/store operation.

9. The system of claim 1, wherein the upstream interface set includes at least a module initialization function, a device initialization function, an asynchronous application execution function, a synchronous application execution function, and an application cleanup function.

10. The system of claim 1, wherein the downstream interface set includes at least a feature initialization function, a support list function, a device configuration function, a license and authentication function, an asynchronous feature execution function, a synchronous feature execution function, and a feature clean-up function.

11. A method comprising:
communicating, by an upstream interface set, with an application that requests a device service using a device;
including a device service circuit in a downstream interface set, the device service circuit providing the device service customized to the device, the device being integrated with the application; and
processing communication requests between the upstream interface set and the downstream interface set by a processing element.

12. The method of claim 11, wherein including the device service circuit comprises: executing a command in the device service; and
extending a service set to include the device service circuit.

13. The method of claim 12, wherein processing communication requests comprises:
routing a command identifier of the command as part of the communication requests by the application to the device service circuit; and
authorizing the application to use the device service based on at least one of a licensing requirement and an authentication operation.

14. The method of claim 11 further comprising:
integrating an input/output (IO) connector with an IO function that accesses the device.

15. The method of claim 14, wherein the device is one of a non-volatile memory express (NVMe) solid-state drive (SSD), a key value (KV) SSD, a flexible data placement (FDP) capable SSD, a cache coherent protocol based SSD, and a high-capacity (HC) SSD.

16. The method of claim 11, wherein the device service is one of cache coherent protocol service, zero-Extract Transform and Load (ETL) service, Quad-level cell (QLC) service, monitoring service, cluster power optimization service, and SSD optimized redundant array of inexpensive disks (RAID) service.

17. The method of claim 13, wherein the IO function performs one of a file system operation, a kernel block device operation, a userspace block device operation, a key value IO stack operation, a persistent memory (PMEM) stack operation, and a load/store operation.

18. A system comprising:
an application requesting a device service using a device; and
a framework configured to respond to the application, the framework comprising:
an upstream interface set configured to interface to an application that requests a device service using the device;
a downstream interface set configured to include a device service circuit that provides the device service customized to the device in a modularized form; and
a processing element configured to process communication requests between the upstream interface set and the downstream interface set,
wherein the device is one of a non-volatile memory express (NVMe) solid-state drive (SSD), a key value (KV) SSD, a flexible data placement (FDP) capable SSD, a cache coherent protocol based SSD, and a high-capacity (HC) SSD.

19. The system of claim 18, wherein the upstream interface set includes at least a functionality initialization function, a device initialization function, an asynchronous application execution function, a synchronous application execution function, and an application cleanup function.

20. The system of claim 18, wherein the downstream interface set includes at least a feature initialization function, a support list function, a device configuration function, a license and authentication function, an asynchronous feature execution function, a synchronous feature execution function, and a feature clean-up function.
